(19) United States
(12) Patent Application Publication
(10) Pub. No.: US 2023/0162006 A1
(43) Pub. Date: May 25, 2023

(54) SERVER AND AGENT FOR REPORTING OF COMPUTATIONAL RESULTS DURING AN ITERATIVE LEARNING PROCESS

(71) Applicant: Telefonaktiebolaget LM Ericsson (publ), Stockholm (SE)

(72) Inventors: Erik G. LARSSON, Linköping (SE); Ema BECIROVIC, Linköping (SE); Zheng CHEN, Norrköping (SE); Reza MOOSAVI, Linköping (SE); Erik ERIKSSON, Linköping (SE); Nicklas JOHANSSON, Linköping (SE)

(73) Assignee: Telefonaktiebolaget LM Ericsson (publ), Stockholm (SE)

(21) Appl. No.: 17/922,741

(22) PCT Filed: Apr. 6, 2021
(86) PCT No.: PCT/EP2021/058938

§ 371 Date: Nov. 1, 2022

(51) Int. Cl. G06N 3/0455; G06N 3/084

(52) U.S. Cl. CPC G06N 3/0455; G06N 3/084

(57) ABSTRACT

There is provided mechanisms for configuring agent entities with a reporting condition for reporting computational results during an iterative learning process. A method is performed by a server entity. The method comprises configuring the agent entities with a computational task and a reporting condition. The agent entities are to contend for channel access to report computational results of the computational task to the server entity only when an importance metric satisfies the reporting condition. The method comprises performing the iterative learning process with the agent entities until a termination criterion is met.

### TECHNICAL FIELD

Embodiments presented herein relate to a method, a server entity, a computer program, and a computer program product for configuring agent entities with a reporting condition for reporting computational results during an iterative learning process. Embodiments presented herein further relate to a method, an agent entity, a computer program, and a computer program product for being configured by the server entity with the reporting condition for reporting computational results during the iterative learning process.

### BACKGROUND

The increasing concerns for data privacy have motivated the consideration of collaborative machine learning systems with decentralized data where pieces of training data are stored and processed locally by edge user devices, such as user equipment. Federated learning (FL) is one non-limiting example of a decentralized learning topology, where multiple (possible very large number of) agents, for example implemented in user equipment, participate in training a shared global learning model by exchanging model updates with a centralized parameter server (PS), for example implemented in a network node.

FL is an iterative process where each global iteration, often referred to as communication round, is divided into three phases: In a first phase the PS broadcasts the current model parameter vector to all participating agents. In a second phase each of the agents performs one or several steps of a stochastic gradient descent (SGD) procedure on its own training data based on the current model parameter vector and obtains a model update. In a third phase the model updates from all agents are sent to the PS, which aggregates the received model updates and updates the parameter vector for the next iteration based on the model updates according to some aggregation rule. The first phase is then entered again but with the updated parameter vector as the current model parameter vector.

A common baseline scheme in FL is named Federated SGD, where in each local iteration, only one step of SGD is performed at each participating agent, and the model updates contain the gradient information. A natural extension is so-called Federated Averaging, where the model updates from the agents contain the updated parameter vector after performing their local iterations.

Consider an FL system with K agents that in collaborative manner train a learning model parametrized by a parameter vector w∈ [symbol] ^{d}, where d is the dimension. Assume that each agent k∈{1, . . . , K} has a local training data set [symbol] ₖ={s₁^{k}, . . . , sₙ_{ₖ}^{k}}, where nₖ=| [symbol] ₖ| is the number of local data samples. The overall training data size is N=Σₖ₌₁^{K}nₖ. The objective of the FL process is to minimize an empirical loss function F(w) expressed as:

$$F ( w ) = {\sum }_{k = 1}^{K} \frac{{n}_{k}}{N} {F}_{k} ( w ) ,$$

where Fₖ(w) is the local loss function at agent k, given by:

$${F}_{k} ( w ) = \frac{1}{{n}_{k}} {\sum }_{i = 1}^{{n}_{k}} f ( w , {s}_{i}^{k} ) ,$$

where f(w, sᵢ^{k}) denotes the loss of the learning model with parameter w on the local data sample sᵢ^{k}. What the loss represents might depend on the computational problem intended to be solved using the FL system. In some non-limiting examples, the loss represents a prediction error, such as mean square error or mean absolute error, that is to be minimized.

During the t:th global iteration, agent k receives the current parameter vector w(t) from the PS, and then performs m steps of SGD, where in each step the local parameter is updated by

wₖ(t,τ+1)=wₖ(t,τ)−ηₖ∇f(k(t,τ),sᵢ^{k}(t,τ)),τ=0, . . . m−1,

where ∇f(wₖ(t,τ), sᵢ^{k}(t,τ)) is the gradient computed from the local data sample sᵢ^{k}(t,τ), which is randomly chosen from [symbol] ₖ in the τ:th local iteration of the t:th communication round. Note that wₖ(t, 0)=w(t) is the model parameter downloaded from the PS at the beginning of the t:th global iteration. After completing the local SGD iterations, each agent k sends wₖ(t+1)=wₖ(t, m) back to the PS, where the parameter vector for the new iteration w(t+1) is updated by a weighted average;

$$w ( t + 1 ) = {\sum }_{k = 1}^{K} \frac{{n}_{k}}{N} {w}_{k} ( t + 1 ) .$$

An equivalent formulation is to let the agents send updates defined by the difference between the parameter vector before and after their local iterations, i.e.,

∇ₖ(t)=wₖ(t,m)−wₖ(t,0).

The PS would then aggregate the received gradients and updates the parameter vector;

$$w ( t + 1 ) = w ( t ) + {\sum }_{k = 1}^{K} \frac{{n}_{k}}{N} {∇}_{k} ( t ) .$$

This iterative process continues until a termination criterion is satisfied. The termination criterion in some non-limiting examples can be when a pre-determined number of iterations have been reached or when the aggregated loss function F(w) has reached a desired value or when the aggregated loss function F(w) does not decrease after one (or several(round(s) of iterations.

Due to the limited communication resources in wireless networks, scheduling (in terms of when in time and/or how (part of an ordinary uplink data transmission, or as part of uplink control information, etc.) any information is to be sent from the agents to the PS) plays a critical role in the communication-efficient design of FL algorithms. Several centralized scheduling policies have been proposed, which considers different types of metrics, such as channel quality, significance of the parameter updates, the age of the updates. Four different scheduling schemes have been proposed and compared; a) including best channel, b) best L2-norm of the gradient update, c) a combination of best channel and best L2-norm of the gradient update, d) and combinations of best channel and best L2-norm that consider constraints on the quantization of the gradient update. In all cases, the PS is responsible for making the scheduling decisions, which inherently means that the PS needs to collect the L2-norm of all the model updates and obtain the channel estimates before making the scheduling decision in every communication round. Such centralized scheduling schemes assume that the PS has full knowledge about the states of all the participating agents, where the states can be related to their channel quality and some other metrics that quantify the importance of the updates.

However, when the number of participating agents grows, centralized scheduling will create significant signaling overhead, communication costs and delays.

### SUMMARY

An object of embodiments herein is to address the above issues in order to enable efficient communication between the PS (hereinafter denoted server entity) and the agents (hereinafter denoted agent entities) whilst reducing the signaling overhead between the PS and the agents.

According to a first aspect there is presented a method for configuring agent entities with a reporting condition for reporting computational results during an iterative learning process. The method is performed by a server entity. The method comprises configuring the agent entities with a computational task and a reporting condition. The agent entities are to contend for channel access to report computational results of the computational task to the server entity only when an importance metric satisfies the reporting condition. The method comprises performing the iterative learning process with the agent entities until a termination criterion is met.

According to a second aspect there is presented a server entity for configuring agent entities with a reporting condition for reporting computational results during an iterative learning process. The server entity comprises processing circuitry. The processing circuitry is configured to cause the server entity to configure the agent entities with a computational task and a reporting condition. The agent entities are to contend for channel access to report computational results of the computational task to the server entity only when an importance metric satisfies the reporting condition. The processing circuitry is configured to cause the server entity to perform the iterative learning process with the agent entities until a termination criterion is met

According to a third aspect there is presented a server entity for configuring agent entities with a reporting condition for reporting computational results during an iterative learning process. The server entity comprises a configure module configured to configure the agent entities with a computational task and a reporting condition. The agent entities are to contend for channel access to report computational results of the computational task to the server entity only when an importance metric satisfies the reporting condition. The server entity comprises a process module configured to perform the iterative learning process with the agent entities until a termination criterion is met.

According to a fourth aspect there is presented a computer program for configuring agent entities with a reporting condition for reporting computational results during an iterative learning process. The computer program comprises computer program code which, when run on processing circuitry of a server entity, causes the server entity to perform a method according to the first aspect.

According to a fifth aspect there is presented a method, performed by an agent entity, for being configured by a server entity with a reporting condition for reporting computational results during an iterative learning process. The method comprises obtaining configuring in terms of a computational task and a reporting condition from the server entity. The agent entity is to contend for channel access to report computational results of the computational task to the server entity only when an importance metric satisfies the reporting condition. The method comprises performing the iterative learning process with the server entity until a termination criterion is met, wherein, as part of the learning process. The agent entity contends for channel access to report a computational result for an iteration of the learning process to the server entity only when the importance metric satisfies the reporting criterion.

According to a sixth aspect there is presented an agent entity for being configured by a server entity with a reporting condition for reporting computational results during an iterative learning process. The agent entity comprises processing circuitry. The processing circuitry is configured to cause the agent entity to obtain configuring in terms of a computational task and a reporting condition from the server entity. The agent entity is to contend for channel access to report computational results of the computational task to the server entity only when an importance metric satisfies the reporting condition. The processing circuitry is configured to cause the agent entity to perform the iterative learning process with the server entity until a termination criterion is met. As part of the learning process. the agent entity contends for channel access to report a computational result for an iteration of the learning process to the server entity only when the importance metric satisfies the reporting criterion.

According to a seventh aspect there is presented an agent entity for being configured by a server entity with a reporting condition for reporting computational results during an iterative learning process. The agent entity comprises an obtain module configured to obtain configuring in terms of a computational task and a reporting condition from the server entity. The agent entity is to contend for channel access to report computational results of the computational task to the server entity only when an importance metric satisfies the reporting condition. The agent entity comprises a process module configured to perform the iterative learning process with the server entity until a termination criterion is met. As part of the learning process. the agent entity contends for channel access to report a computational result for an iteration of the learning process to the server entity only when the importance metric satisfies the reporting criterion.

According to an eighth aspect there is presented a computer program for being configured by a server entity with a reporting condition for reporting computational results during an iterative learning process. The computer program comprises computer program code which, when run on processing circuitry of an agent entity, causes the agent entity to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these methods, these server entities, these agent entities, these computer programs, and this computer program product provide efficient communication between the server entity and the agent entities whilst reducing the signaling overhead between the server entity and the agent entities.

Advantageously, these methods, these server entities, these agent entities, these computer programs, and this computer program product enable the need for a scheduling mechanism at the server entity to be circumvented, as each agent entity, based on the configuring from the server entity, on its own decides whether to contend for channel access based on its own quality metric.

Advantageously, these methods, these server entities, these agent entities, these computer programs, and this computer program product avoid excessive information exchange between the server entity and the participating agent entities in each global iteration

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, action, etc.” are to be interpreted openly as referring to at least one instance of the element, apparatus, component, means, module, action, etc., unless explicitly stated otherwise. The actions of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2, 3, and 4 are flowcharts of methods according to embodiments;

FIG. 5 is a signalling diagram according to an embodiment;

FIG. 6 is a schematic illustration of a CSI compression process according to an embodiment;

FIG. 7 is a schematic diagram showing functional units of a server entity according to an embodiment;

FIG. 8 is a schematic diagram showing functional modules of a server entity according to an embodiment;

FIG. 9 is a schematic diagram showing functional units of an agent entity according to an embodiment;

FIG. 10 is a schematic diagram showing functional modules of an agent entity according to an embodiment; and

FIG. 11 shows one example of a computer program product comprising computer readable means according to an embodiment;

FIG. 12 is a schematic diagram illustrating a telecommunication network connected via an intermediate network to a host computer in accordance with some embodiments; and

FIG. 13 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any action or feature illustrated by dashed lines should be regarded as optional.

The wording that a certain data item, piece of information, etc. is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item, piece of information, etc. is provided by a first device to a second device should be construed as that data item or piece of information being sent or otherwise made available to the second device by the first device. For example, the data item or piece of information might either be pushed to the second device from the first device or pulled by the second device from the first device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device.

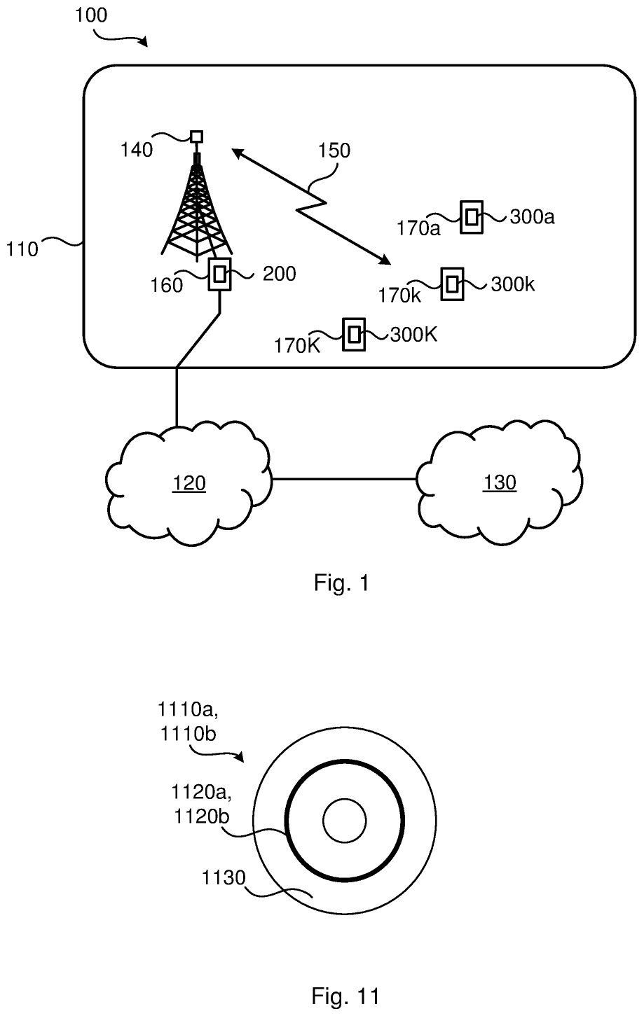

FIG. 1 is a schematic diagram illustrating a communication network 100 where embodiments presented herein can be applied. The communication network 100 could be a third generation (3G) telecommunications network, a fourth generation (4G) telecommunications network, a fifth (5G) telecommunications network, a sixth (6G) telecommunications network, and support any 3GPP telecommunications standard.

The communication network 100 comprises a transmission and reception point 140 configured to provide network access to user equipment 170a, 170k, 170K in an (radio) access network 110 over a radio propagation channel 150. The access network 110 is operatively connected to a core network 120. The core network 120 is in turn operatively connected to a service network 130, such as the Internet. The user equipment 170a:170K is thereby, via the transmission and reception point 140, enabled to access services of, and exchange data with, the service network 130.

Operation of the transmission and reception point 140 is controlled by a controller 160. The controller 160 might be part of, collocated with, or integrated with the transmission and reception point 140.

Examples of network nodes 160 are (radio) access network nodes, radio base stations, base transceiver stations, Node Bs (NBs), evolved Node Bs (eNBs), gNBs, access points, access nodes, and integrated access and backhaul nodes. Examples of user equipment 170a:170K are wireless devices, mobile stations, mobile phones, handsets, wireless local loop phones, smartphones, laptop computers, tablet computers, network equipped sensors, network equipped vehicles, and so-called Internet of Things devices.

It is assumed that the user equipment 170a:170K are to be utilized during an iterative learning process and that the user equipment 170a:170K as part of performing the iterative learning process are to report computational results to the network node 160. The network node 160 therefore comprises, is collocated with, or integrated with, a server entity 200. Each of the user equipment 170a:170K comprises, is collocated with, or integrated with, a respective agent entity 300a:300K 300a, 300k, 300K.

As disclosed above, when the number of participating agent entities 300a:300K grows, centralized scheduling at the sever 200 will create significant signaling The embodiments disclosed herein thus relate to mechanisms for a server entity 200 to configure agent entities 300a:300K with a reporting condition for reporting computational results during an iterative learning process and for an agent entity 300k to be configured by a server entity 200 with a reporting condition for reporting computational results during an iterative learning process. In order to obtain such mechanisms there is provided a server entity 200, a method performed by the server entity 200, a computer program product comprising code, for example in the form of a computer program, that when run on processing circuitry of the server entity 200, causes the server entity 200 to perform the method. In order to obtain such mechanisms there is further provided an agent entity 300k, a method performed by the agent entity 300k, and a computer program product comprising code, for example in the form of a computer program, that when run on processing circuitry of the agent entity 300k, causes the agent entity 300k to perform the method.

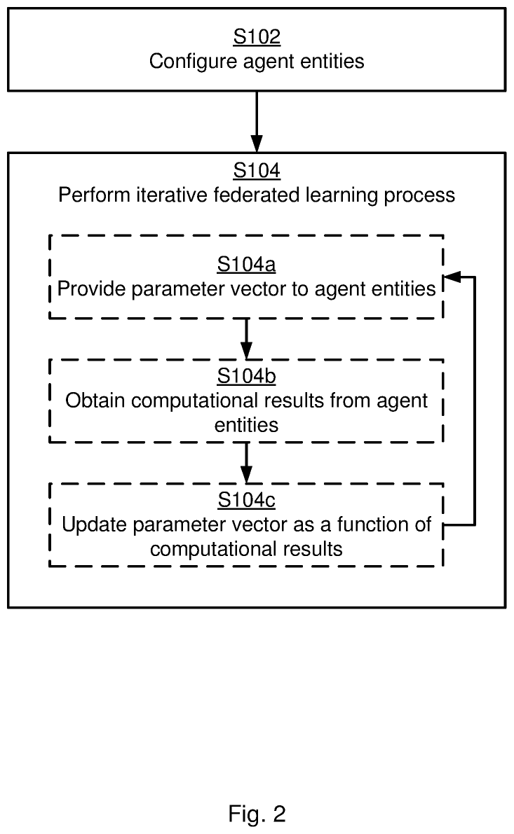

Reference is now made to FIG. 2 illustrating a method for configuring agent entities 300a:300K with a reporting condition for reporting computational results during an iterative learning process as performed by the server entity 200 according to an embodiment.

S102: The server entity 200 configures the agent entities 300a:300K with a computational task and a reporting condition. The agent entities 300a:300K are configured to contend for channel access to report computational results of the computational task to the server entity 200 only when an importance metric mₖ(t) satisfies the reporting condition. Here, mₖ(t) denotes the importance metric of agent k in the t:th iteration of the iterative learning process.

S104: The server entity 200 performs the iterative learning process with the agent entities 300a:300K until a termination criterion is met.

Embodiments relating to further details of the server entity 200 configuring agent entities 300a:300K with the reporting condition for reporting the computational results during the iterative learning process as performed by the server entity 200 will now be disclosed.

There may be different ways to perform the iterative learning process. In some embodiments, the server entity 200 is configured to perform (optional) actions S104a, S104b, S104c during each iteration of the iterative learning process (in action S104):

S104a: The server entity 200 provides a parameter vector of the computational task to the agent entities 300a:300K;

S104b: The server entity 200 obtains, in accordance with the reporting condition, computational results as a function of the parameter vector from the agent entities 300a:300K; and

S104c: The server entity 200 updates the parameter vector as a function of an aggregate of the obtained computational results when the aggregate of the obtained computational results for the iteration fails to satisfy the termination criterion.

There could be different ways in which the importance metric mₖ(t) might satisfy the reporting condition. In some embodiments, the importance metric mₖ(t) satisfies the reporting condition when the importance metric mₖ(t) exceeds a threshold value tₖ. Further aspects thereof will be disclosed below.

There could be different ways in which the agent entity 300k (or the user equipment 170k in which the agent entity 300k resides) to contend for channel access. In some embodiments, according to the configuring, the agent entities 300a:300K (or the user equipment 170a:170K in which the agent entities 300a:300K reside) are to contend for channel access by performing a random access procedure. Hence, in some aspects, when the user equipment 170k in which the agent entity 300k resides needs to access the communication network 100, the user equipment 170k performs a random access procedure. Whereas an example of how random access is performed in a communication network 100 uses a Long Term Evolution (LTE) radio access technology (RAT) will be described next, it is noted that the herein disclosed embodiments apply equally regardless of the type of RAT. Similar random access procedures as applicable for the herein disclosed embodiments also exist for other RATs, such as New Radio (NR). Random access in LTE may either be configured as contention-based random access (CBRA), and implying an inherent risk of collision, or contention-free, where resources are reserved by the network node 160 to a given user equipment 170k at a given time. In a CBRA procedure, a random access channel (RACH) preamble is randomly selected by the user equipment 170k, which may result in more than one user equipment 170k simultaneously transmitting the same signature, leading to a need for a subsequent contention resolution process. For some scenarios where random access is used, e.g., handovers, the network node 160 has the option of preventing contention occurring by allocating a dedicated signature to a user equipment 170k, resulting in contention-free access. This is faster than contention-based access—a particularly important factor for the case of handover, which is time-critical, though it requires the network to reserve resources, which may not be very efficient. A fixed number (64) of preambles is available in each cell of a communication network 100 based on LTE, and the operation of the two types of random access procedure depends on a partitioning of these signatures between those for contention-based access and those reserved for allocation to specific user equipment 170k on a contention-free basis.

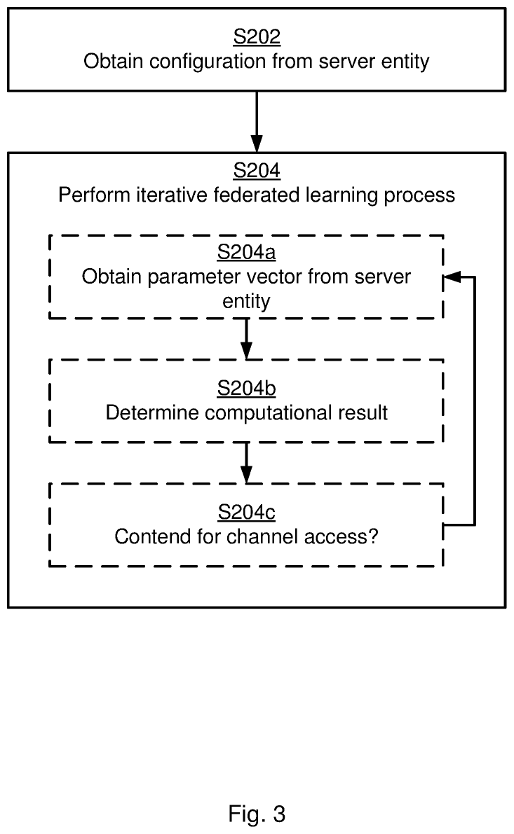

Reference is now made to FIG. 3 illustrating a method for an agent entity 300k to be be configured by a server entity 200 with a reporting condition for reporting computational results during an iterative learning process as performed by the agent entity 300k according to an embodiment.

S202: The agent entity 300k obtains configuring in terms of a computational task and a reporting condition from the server entity 200. The agent entity 300k is configured to contend for channel access to report computational results of the computational task to the server entity 200 only when an importance metric mₖ(t) satisfies the reporting condition.

S204: The agent entity 300k performs the iterative learning process with the server entity 200 until a termination criterion is met. As part of the learning process, the agent entity 300k contends for channel access to report a computational result for an iteration of the learning process to the server entity 200 only when the importance metric mₖ(t) satisfies the reporting criterion.

Embodiments relating to further details of the agent entity 300 being configured by the server entity 200 with the reporting condition for reporting the computational results during the iterative learning process as performed by the agent entity 300k will now be disclosed.

As disclosed above, there may be different ways to perform the iterative learning process. In some embodiments, the agent entity 300k is configured to perform (optional) actions S204a, S204b, S204c during each iteration of the iterative learning process (in action S204): S204a: The agent entity 300k obtains a parameter vector of the computational task from the server entity 200.

S204b: The agent entity 300k determines the computational result of the computational task as a function of the obtained parameter vector for the iteration and of data locally obtained by the agent entity 300k.

S204c: The agent entity 300k contends for channel access to report the computational result for the iteration to the server entity 200 only when the importance metric mₖ(t) satisfies the reporting criterion.

Aspects of the importance metric will now be disclosed. As above, let mₖ(t) denote the importance metric of agent k in the t:th iteration of the iterative learning process. In general, this metric is a function of its current state Sₖ(t). The state of an agent can for example be related to the norm of its gradient update, current channel quality, how may iterations since last contention for channel access, how may iterations since last actual reporting, variation in channel quality, locally updated parameter, or any combination of several factors.

As disclosed above, there could be different ways in which the importance metric mₖ(t) might satisfy the reporting condition. In some embodiments, the importance metric mₖ(t) satisfies the reporting condition when the importance metric mₖ(t) exceeds a threshold value tₖ. Further embodiments relating thereto will now be disclosed in turn. Although these embodiments are based on that the importance metric mₖ(t) satisfies the reporting condition when the importance metric mₖ(t) exceeds the threshold value tₖ, other criteria for when the importance metric mₖ(t) satisfies the reporting condition are also applicable.

In some embodiments, the importance metric mₖ(t) is a function of a gradient update ∥∇ₖ(t)∥ computed by the agent entity 300k as part of determining the computational result for iteration t of the iterative learning process. The importance metric mₖ(t) then satisfies the reporting condition when the gradient update ∥∇ₖ(t)∥ exceeds the threshold value tₖ. That is, contention for channel access is made only when the gradient update for iteration t exceeds the threshold value tₖ. Thus, in some examples the state at least represents the gradient update, e.g., Sₖ(t)=∇ₖ(t), where ∇ₖ(t) represents the gradient update of agent k in the t:th ration of the iterative learning process. The importance metric mₖ(t) can then be measured in terms of the norm of the gradient, or the normalized gradient:

mₖ(t)=|∇ₖ(t)∥,

or in alternatively:

$${m}_{k} ( t ) = \frac{‖ {∇}_{k} ( t ) ‖}{‖ w ‖} .$$

Let hₖ(t) denote the channel gain of agent k. In some embodiments, the importance metric mₖ(t) is a function of a channel quality value hₖ(t), as valid for iteration t of the iterative learning process, for a radio propagation channel over which the computational result is to be reported. The importance metric mₖ(t) then satisfies the reporting condition when the channel quality value hₖ(t) exceeds the threshold value tₖ. That is, contention for channel access for iteration t is made only when the channel quality as valid for iteration t exceeds the threshold value tₖ. This implies that Sₖ(t)=hₖ(t). Thus, in some examples the state at least represents the channel gain between the server entity 200 and the agent entity 300k.

In further examples, the state at least represents a combination of the gradient update and the channel gain between the server entity 200 and the agent entity 300k. Thus, Sₖ(t)=[∇ₖ(t), hₖ(t)]. Then, for instance, mₖ(t)=∥∇ₖ(t)∥·1{hₖ(t)>hₜ}, where hₜ denotes the channel quality threshold. Similarly, in the case of multiple-input multiple-output (MIMO) communication, the importance metric mₖ(t) may depend on the norm of the channel, i.e., mₖ(t)=∥∇ₖ(t)∥·1{∥hₖ(t)∥>hₜ}.

In some aspects, the importance metric depends on how many iterations have been made since last contention for channel access. Particularly, in some embodiments, the importance metric mₖ(t) is a function of number of iterations n since recent-most contention for channel access was made. The importance metric mₖ(t) then satisfies the reporting condition when the number of iterations n of the iterative learning process exceeds the threshold value tₖ. That is, contention for channel access is made only when the number of iterations n of the iterative learning process exceeds the threshold value tₖ.

In some aspects, the importance metric depends on how many iterations have been made since last actual reporting. Particularly, in some embodiments, the importance metric mₖ(t) is a function of number of iterations n of the iterative learning process since recent-most reporting of the computational result was made. The importance metric mₖ(t) then satisfies the reporting condition when the number of iterations n of the iterative learning process since recent-most reporting of the computational result exceeds the threshold value tₖ. That is, contention for channel access is made only when the number of iterations n exceeds the threshold value tₖ.

Thus, in some examples the state at least represents the past contention decisions. In further examples, the state at least represents a combination of the gradient update, the channel gain, and the past contention decisions. Here Sₖ(t)=[∇ₖ(t), hₖ(t), Sₖ(1), . . . , Sₖ(t−1)]. For example, mₖ(t)=∥∇ₖ(t)∥·uₖ(t), where

$${u}_{k} ( t ) = \frac{1}{1 + {\sum }_{i = 1}^{W} 1 \{ agent conteded in iteration ( t - i ) \}} .$$

In this way, an agent entity 300k that has not contended for the channel during the last W iterations will get a higher importance metric mₖ(t).

In some embodiments, the importance metric mₖ(t) is a function of channel variation, over at least two iterations of the iterative learning process, of a radio propagation channel over which the computational result is to be reported. The importance metric mₖ(t) then satisfies the reporting condition when the channel variation exceeds the threshold value tₖ. That is, contention for channel access is made only when the channel variation exceeds the threshold value tₖ. Thus, in some examples the state at least represents the variation in channel quality. In further examples, the state at least represents a combination of the gradient update, and all past channel gains. Thus, Sₖ(t)=[∇ₖ(t), hₖ(1), . . . , hₖ(t)]. In this case, the agent entity 300k can take into consideration the variations in the channel. For example,

$${m}_{k} ( t ) = ‖ {∇}_{k} ( t ) ‖ \cdot 1 \{ \frac{‖ {h}_{k} ( t ) ‖}{\frac{1}{t - 1} {\sum }_{i = 1}^{t - 1} ‖ {h}_{k} ( i ) ‖} > {h}_{t} \} .$$

It is here noted that not all past channel gains might be taken into consideration but only the L recent most channel gains. This can be accomplished by using a sliding window. Further, in some aspects, the different channel gains within the sliding window are weighted. In this way, more recent channel gains can be given higher weights than not so recent channel gains.

In some embodiments, the importance metric mₖ(t) is a function of a local parameter updated as part of performing a recent-most iteration of the iterative learning process. The importance metric mₖ(t) then satisfies the reporting condition when the local parameter exceeds the threshold value tₖ. That is, contention for channel access is made only when the local parameter exceeds the threshold value tₖ.

Thus, in some examples the state at least represents the local parameter updates of the computational task. Then, Sₖ(t)=[wₖ(t, 0), . . . , wₖ(t, m)]. The importance metric mₖ(t) might then be a function of the local parameter updates of the computational task. For instance, the mean of the variances of the updates in each dimension can be used when determining the importance metric mₖ(t) as follows:

$${m}_{k} ( t ) = \frac{1}{m + 1} {\sum }_{i = 0}^{m} ( \frac{1}{d} {\sum }_{j = 1}^{d} {[ {w}_{k} ( t , i ) ]}_{j}^{2} + {( \frac{1}{d} {\sum }_{j = 1}^{d} {[ {w}_{k} ( t , i ) ]}_{j} )}^{2} ) ,$$

where [wₖ(t, i)]ⱼ is the update of the j:th dimension in the i:th local iteration for the k:th agent entity in the t:th iteration of the iterative learning process.

As disclosed above, in some embodiments, the importance metric mₖ(t) satisfies the reporting condition when the importance metric mₖ(t) exceeds a threshold value tₖ. That is, in some aspects, when the importance metric mₖ(t) is greater than the threshold tₖ, the agent entity 300k will contend for channel access. More precisely, agent entity 300k k may decide to contend for channel access only when mₖ(t)>tₖ.

Further aspects of the threshold value tₖ will now be disclosed.

In some aspects, the importance metric mₖ(t) is mapped onto an access probability value p through a pre-determined function. A uniformly distributed random variable x is generated in the interval [0, 1]. Then only if x<p then the agent entity 300k contends for channel access. Thus mₖ(t) can be mapped to the space [0,1] and the probability that the agent entity 300k contends for channel is larger if p is close to 1, but there is still a non-zero probability that the agent entity 300k does not contend for channel access even if p is close to 1. Such randomization can be used in scenarios where there is a large number of agent entity 300k, possibly determining whether or not to contend for channel access at the same time. Hence, in some embodiments, the importance metric mₖ(t) is mapped onto an access probability value p, and contention for channel access is made only when p>x, where x is a uniformly distributed random variable in an interval [0, 1] and defines the threshold value tₖ.

In some aspects, the threshold corresponds to a required quality of service (QoS) value, and reporting is made only if the reporting can be made at the required QoS value. In particular, in some embodiments, the importance metric mₖ(t) is a function of an attainable QoS value as attainable when reporting over the radio propagation channel. The threshold value tₖ can then be mapped onto a required QoS value as required for reporting the computational result, and contention for channel access for iteration t is made only when the attainable QoS value exceeds the required QoS value.

Thus, in some aspects, the decision whether to contend for channel access or not for an iteration is not directly mapped to an access decision but instead enables the agent entity 300k to map the update message to different QoS streams. The decision to contend for channel access can then be based on access rules in the physical layer. These rules can in turn be based on the QoS indication, together with radio related aspects such as channel quality, load and power consumption, etc. Hence, in some embodiments, the attainable QoS value is determined from a channel quality value hₖ(t), as valid for iteration t, for a radio propagation channel over which the computational result is to be reported.

As disclosed above, in some embodiments, according to the configuring, contending for channel access comprises the agent entity 300k (or the agent entity 300k to trigger a user equipment 170k in which the agent entity 300k resides) to perform a random access procedure.

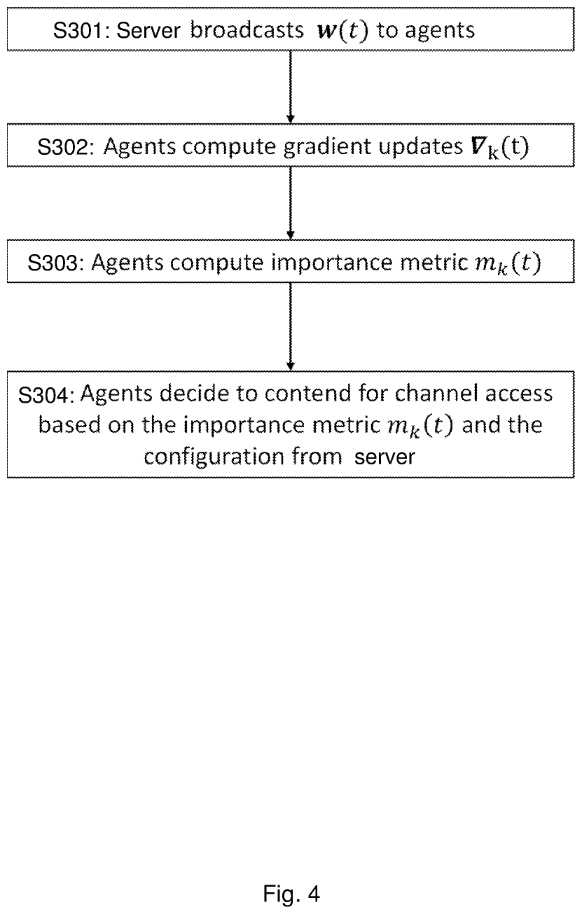

One particular embodiment for the serve entity 200 to configure agent entities 300a:300K with a reporting condition for reporting computational results during an iterative learning process and for the agent entity 300k to be configured by the server entity 200 with the reporting condition for reporting the computational results during the iterative learning process based on at least some of the above disclosed embodiments will now be disclosed in detail with reference to the flowchart of FIG. 4. In this embodiment, the computational result of the computational problem is represented by the SGD.

S301: In each iteration of the iterative learning process, the server entity 200 broadcasts the current model parameter vector to all participating agent entity 300k.

S302: Each agent entity 300k performs one round of the SGD on their locally obtained data and computes its gradient update.

S303: Each agent entity 300k computes a value of its importance metric mₖ(t) based on its own state in the current iteration.

S304: Based on the value of importance metric mₖ(t) and the configuration from the server entity 200, the agent entity 300k decides to either contend for channel access or not.

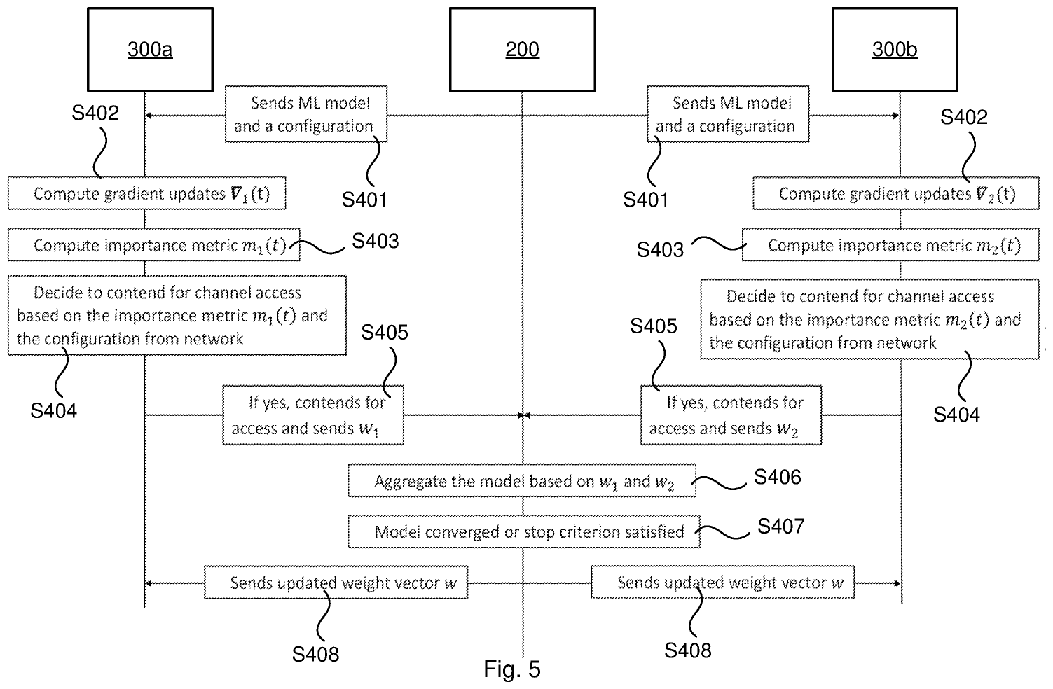

One particular embodiment for the serve entity 200 to configure agent entities 300a:300K with a reporting condition for reporting computational results during an iterative learning process and for the agent entity 300k to be configured by the server entity 200 with the reporting condition for reporting the computational results during the iterative learning process based on at least some of the above disclosed embodiments will now be disclosed in detail with reference to the signalling diagram of FIG. 5, involving the serve entity 200 and two agent entities 300a, 300b, and thus where k=a, b.

S401: The server entity 200 configures the agent entities 300a, 300b with a Machine Learning (ML) problem to be solved, and configuration of a reporting criterion.

S402: Each agent entity 300a, 300b computes a gradient update ∇ₖ(t) based on the obtained parameter vector w(t) and locally obtained data.

S403: Each agent entity 300a, 300b computes value of its importance metric mₖ(t). Without loss of generality, mₖ(t)=∥∇ₖ(t)∥.

S404: Each agent entity 300a, 300b determines whether to contend or not contend for channel access by comparing the importance metric mₖ(t) to a threshold value tₖ. Without loss of generality, agent entity 300a, 300b decides to contend for channel access only when mₖ(t)>tₖ.

S405: It is assumed that the agent entities 300a, 300b contend for channel access in order to report parameter vector wₖ(t) to the server entity 200.

S406: The server entity 200 computes an aggregate of all received parameter vectors wₖ(t) for the t:th global iteration.

S407: The server entity 200 checks whether a termination criterion is met or not.

S408: When the termination criterion is not met, the server entity 200 computes an updated parameter vector w(t+1) based on the aggregate of all received parameter vectors wₖ(t) and provides the updated parameter vector w(t+1) to the agent entity 300a, 300b. The agent entity 300a, 300b the again enters action S402 for a next iteration, thus with t: =t+1.

Illustrative examples where the herein disclosed embodiments apply will now be disclosed.

According to a first example, the computational task pertains to prediction of best secondary carrier frequencies to be used by user equipment 170a:170K in which the agent entities 300a:300K are provided. The data locally obtained by the agent entity 300k can then represent a measurement on a serving carrier of the user equipment 170k. In this respect, the best secondary carrier frequencies for user equipment 170a:170K can be predicted based on their measurement reports on the serving carrier. In order to enable such a mechanism, the agent entities 300a:300K can be trained by the server entity 200, where each agent entity 300k takes as input the measurement reports on the serving carrier(s) (among possibly other available reports such as timing advance, etc.) and as outputs a prediction of whether the user equipment 170k in which the agent entity 300k is provided has coverage or not in the secondary carrier frequency.

In this context, information of the location of the user equipment 300k can be utilized when predicting the secondary carrier. However, due to privacy issues related to location reporting, the network node 160 might not have access to the exact location of its served user equipment 170a:170K. One way to address this issue is to instruct the agent entities 300a:300K in the user equipment 170a:170K to use information of the geographical location of the user equipment 170a:170K to assist network decisions, i.e., offload processing/learning or/and in prediction without explicitly sharing the location in the context of federated learning (FL). In this case, the server entity 200 might broadcast the model and parameter vector and the agent entities 300a:300K use the model and their local measurements along with the location and send reports back to the server entity 200.

The prediction of best secondary carrier frequencies to be used by user equipment 170a:170K can thus be improved according to the herein disclosed embodiments. One reason for this is that in one cell, there are many user equipment 170a:170K located in different locations with different radio qualities and, according to the herein disclosed embodiments, an accurate model can be built that combines the information from all available user equipment 170a:170K.

To achieve the best performance, as many independent agent entities 300a:300K as possible should be utilized and hence the server entity 200 should obtain reporting of computational results from as many agent entities 300a:300K as possible. However, as it can be understood, this approach requires significant signaling between the server entity 200 and the agent entities 300a:300K, and hence between the network node 160 and the user equipment 170a:170K. According to the herein disclosed embodiments, such excessive signaling can be avoided as the agent entities 300a:300K will first compute the importance metric mₖ(t) for each iteration and only contend for channel access once the importance metric mₖ(t) satisfies a reporting criterion as configured by the server entity 200.

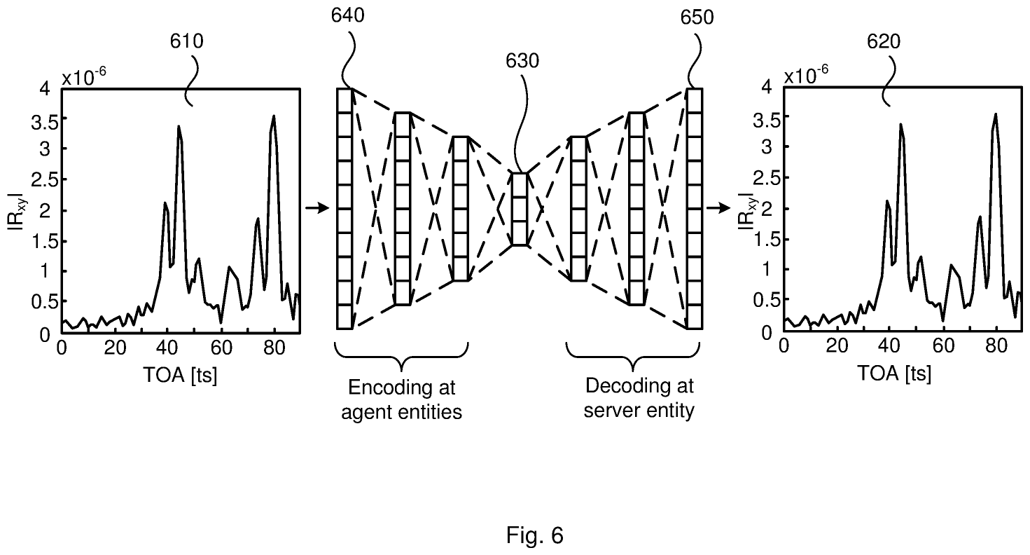

According to a second example, the computational task pertains to compressing channel-state-information using an auto-encoder, where the server entity 200 implements a decoder of the auto-encoder, and where each of the agent entities 300a:300K implements a respective encoder of the auto-encoder. An autoencoder can be regarded as a type of neural network used to learn efficient data representations (denoted by code hereafter). One example of an autoencoder comprising an encoder/decoder for CSI compression is shown in the block diagram of FIG. 6. In this example, the absolute values of the Channel Impulse Response (CIR), as represented by input 640, are, at the agent entities 300a:300K, compressed to a code 630, and then the resulting code is, at the server entity 200, decoded to reconstruct the measured CIR, as represented by output 650. The reconstructed CIR 620 is almost identical to the original CIR 610. The CIR 610, 620 is plotted in terms of the magnitude of the cross-correlation |R_{xy}| between a transmit signal and a receive signal as a function of time of arrival (TOA) in units of the physical layer time unit Ts, where 1 Ts=1/30720000 seconds. In practice, instead of transmitting raw CIR values from the user equipment 170a:170K to the network node 160, the agent entities 300a:300K thus encode the raw CIR values using the encoders and report the resulting code to the server entity 200. The server entity 200, upon reception of the code from the agent entities 300a:300K, reconstructs the CIR values using the decoder. Since the code can be sent with fewer information bits, this will result in significant signaling overhead reduction. The reconstruction accuracy can be further enhanced if as many independent agent entities 300a:300K as possible are utilized. This can be achieved by enabling each agent entity 300k to contribute to training a global model preserved at the server entity 200. The herein disclosed embodiments can be applied to avoid significant signaling between signaling between the server entity 200 and the agent entities 300a:300K, and hence between the network node 160 and the user equipment 170a:170K. Accordingly, the agent entities 300a:300K will first compute the importance metric mₖ(t) for each iteration and only contend for channel access once the importance metric mₖ(t) satisfies a reporting criterion as configured by the server entity 200.

According to a third example, the computational task pertains to spectrum sharing. In this respect, the herein disclosed embodiments can be used to dynamically allocate available frequencies to different radio access technologies (such as between a 4G telecommunications network and a 5G telecommunications network). Traditionally, spectrum sharing is performed according to schemes that heavily involve message exchange between different network entities using available inter-node interfaces (such as the X2 interface and the Xn interface). As the cells have different radio characteristics, the herein disclosed embodiments can be used to enhance the learning process. In this case, each of the agent entities 300a:300K could be provided a respective access network node and will not contend for channel access to an air interface but for content for accessing the inter-node interfaces. Hence, the channel is here represented by the inter-node interfaces. For example, one access network node can refrain from sending its updates on the inter-node interfaces if the importance metric is below a threshold and hence no messages will be exchanged over Xn.

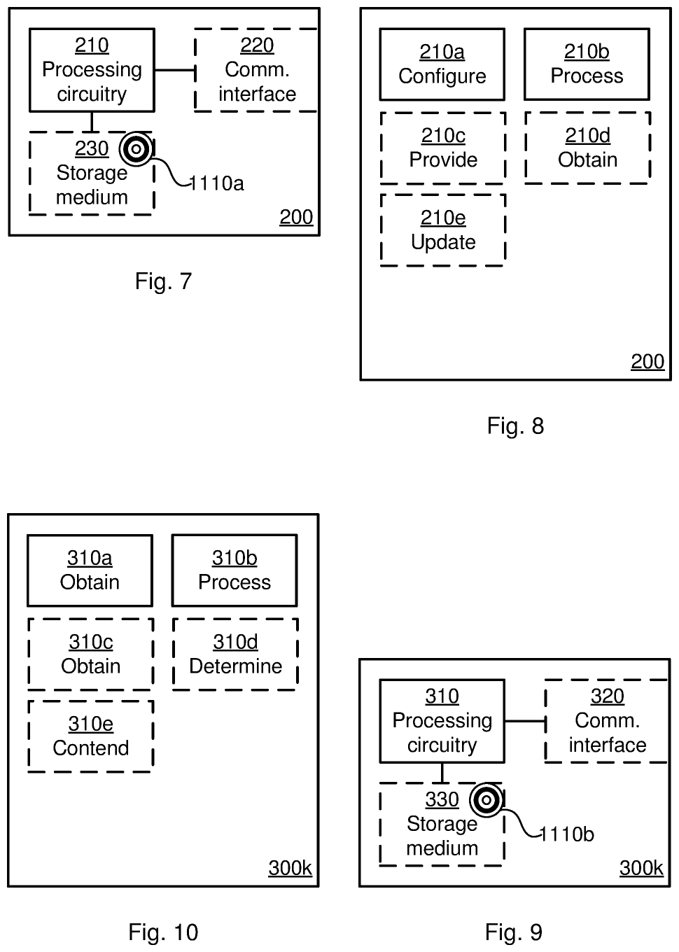

FIG. 7 schematically illustrates, in terms of a number of functional units, the components of a server entity 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1110a (as in FIG. 11), e.g. in the form of a storage medium 230. The processing circuitry 210 may further be provided as at least one application specific integrated circuit (ASIC), or field programmable gate array (FPGA).

Particularly, the processing circuitry 210 is configured to cause the server entity 200 to perform a set of operations, or actions, as disclosed above. For example, the storage medium 230 may store the set of operations, and the processing circuitry 210 may be configured to retrieve the set of operations from the storage medium 230 to cause the server entity 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The server entity 200 may further comprise a communications interface 220 for communications with other entities, functions, nodes, and devices, either directly or indirectly. As such the communications interface 220 may comprise one or more transmitters and receivers, comprising analogue and digital components.

The processing circuitry 210 controls the general operation of the server entity 200 e.g. by sending data and control signals to the communications interface 220 and the storage medium 230, by receiving data and reports from the communications interface 220, and by retrieving data and instructions from the storage medium 230. Other components, as well as the related functionality, of the server entity 200 are omitted in order not to obscure the concepts presented herein.

FIG. 8 schematically illustrates, in terms of a number of functional modules, the components of a server entity 200 according to an embodiment. The server entity 200 of FIG. 8 comprises a number of functional modules; a configure module 210a configured to perform action S102, and a process module 210b configured to perform action S104. The server entity 200 of FIG. 8 may further comprise a number of optional functional modules, such as any of a provide module 210c configured to perform action S204a, an obtain module 210d configured to perform action S204b, and an update module 210e configured to perform action S204c. In general terms, each functional module 210a:210e may be implemented in hardware or in software. Preferably, one or more or all functional modules 210a:210e may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210e and to execute these instructions, thereby performing any actions of the server entity 200 as disclosed herein.

The server entity 200 may be provided as a standalone device or as a part of at least one further device. Thus, a first portion of the instructions performed by the server entity 200 may be executed in a first device, and a second portion of the instructions performed by the server entity 200 may be executed in a second device; the herein disclosed embodiments are not limited to any particular number of devices on which the instructions performed by the server entity 200 may be executed. Hence, the methods according to the herein disclosed embodiments are suitable to be performed by a server entity 200 residing in a cloud computational environment. Therefore, although a single processing circuitry 210 is illustrated in FIG. 7 the processing circuitry 210 may be distributed among a plurality of devices, or nodes. The same applies to the functional module 210a:210e of FIG. 8 and the computer program 1120a of FIG. 11.

FIG. 9 schematically illustrates, in terms of a number of functional units, the components of an agent entity 300k according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1110b (as in FIG. 11), e.g. in the form of a storage medium 330. The processing circuitry 310 may further be provided as at least one application specific integrated circuit (ASIC), or field programmable gate array (FPGA). Particularly, the processing circuitry 310 is configured to cause the agent entity 300k to perform a set of operations, or actions, as disclosed above. For example, the storage medium 330 may store the set of operations, and the processing circuitry 310 may be configured to retrieve the set of operations from the storage medium 330 to cause the agent entity 300k to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The agent entity 300k may further comprise a communications interface 320 for communications with other entities, functions, nodes, and devices, either directly or indirectly. As such the communications interface 320 may comprise one or more transmitters and receivers, comprising analogue and digital components.

The processing circuitry 310 controls the general operation of the agent entity 300k e.g. by sending data and control signals to the communications interface 320 and the storage medium 330, by receiving data and reports from the communications interface 320, and by retrieving data and instructions from the storage medium 330. Other components, as well as the related functionality, of the agent entity 300k are omitted in order not to obscure the concepts presented herein.

FIG. 10 schematically illustrates, in terms of a number of functional modules, the components of an agent entity 300k according to an embodiment. The agent entity 300k of FIG. 10 comprises a number of functional modules; an obtain module 310a configured to perform action S202, and a process module 310b configured to perform action S204. The agent entity 300k of FIG. 10 may further comprise a number of optional functional modules, such as any of an obtain module 310c configured to perform action S204a, a determine module 310d configured to perform action S204b, and a contend module 310e configured to perform action S204c. In general terms, each functional module 310a:310e may be implemented in hardware or in software. Preferably, one or more or all functional modules 310a:310e may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310e and to execute these instructions, thereby performing any actions of the agent entity 300k as disclosed herein.

The agent entity 300k may be provided as a standalone device or as a part of at least one further device. Thus, a first portion of the instructions performed by the agent entity 300k may be executed in a first device, and a second portion of the instructions performed by the agent entity 300k may be executed in a second device; the herein disclosed embodiments are not limited to any particular number of devices on which the instructions performed by the agent entity 300k may be executed. Hence, the methods according to the herein disclosed embodiments are suitable to be performed by a agent entity 300k residing in a cloud computational environment. Therefore, although a single processing circuitry 210, 310 is illustrated in FIG. 9 the processing circuitry 210, 310 may be distributed among a plurality of devices, or nodes. The same applies to the functional module 310a:310e of FIG. 10 and the computer program 1120b of FIG. 11.

FIG. 11 shows one example of a computer program product 1110a, 1110b comprising computer readable means 1130. On this computer readable means 1130, a computer program 1120a can be stored, which computer program 1120a can cause the processing circuitry 210 and thereto operatively coupled entities and devices, such as the communications interface 220 and the storage medium 230, to execute methods according to embodiments described herein. The computer program 1120a and/or computer program product 1110a may thus provide means for performing any actions of the server entity 200 as herein disclosed. On this computer readable means 1130, a computer program 1120b can be stored, which computer program 1120b can cause the processing circuitry 310 and thereto operatively coupled entities and devices, such as the communications interface 320 and the storage medium 330, to execute methods according to embodiments described herein. The computer program 1120b and/or computer program product 1110b may thus provide means for performing any actions of the agent entity 300k as herein disclosed.

In the example of FIG. 11, the computer program product 1110a, 1110b is illustrated as an optical disc, such as a CD (compact disc) or a DVD (digital versatile disc) or a Blu-Ray disc. The computer program product 1110a, 1110b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1120a, 1120b is here schematically shown as a track on the depicted optical disk, the computer program 1120a, 1120b can be stored in any way which is suitable for the computer program product 1110a, 1110b.

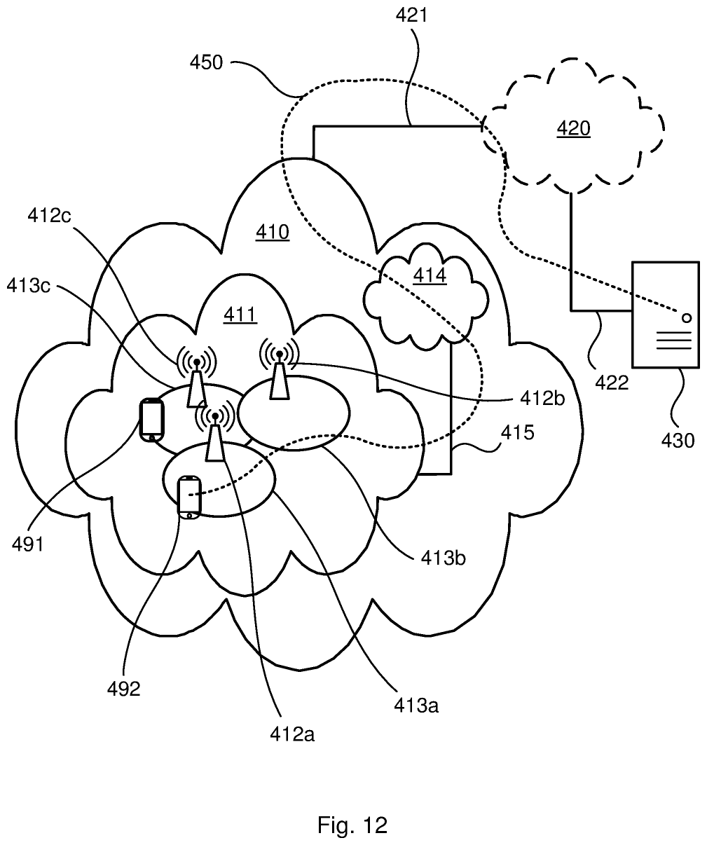

FIG. 12 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as radio access network 110 in FIG. 1, and core network 414, such as core network 120 in FIG. 1. Access network 411 comprises a plurality of radio access network nodes 412a, 412b, 412c, such as NBs, eNBs, gNBs (each corresponding to the network node 160 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the UEs 170a:170K of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 12 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

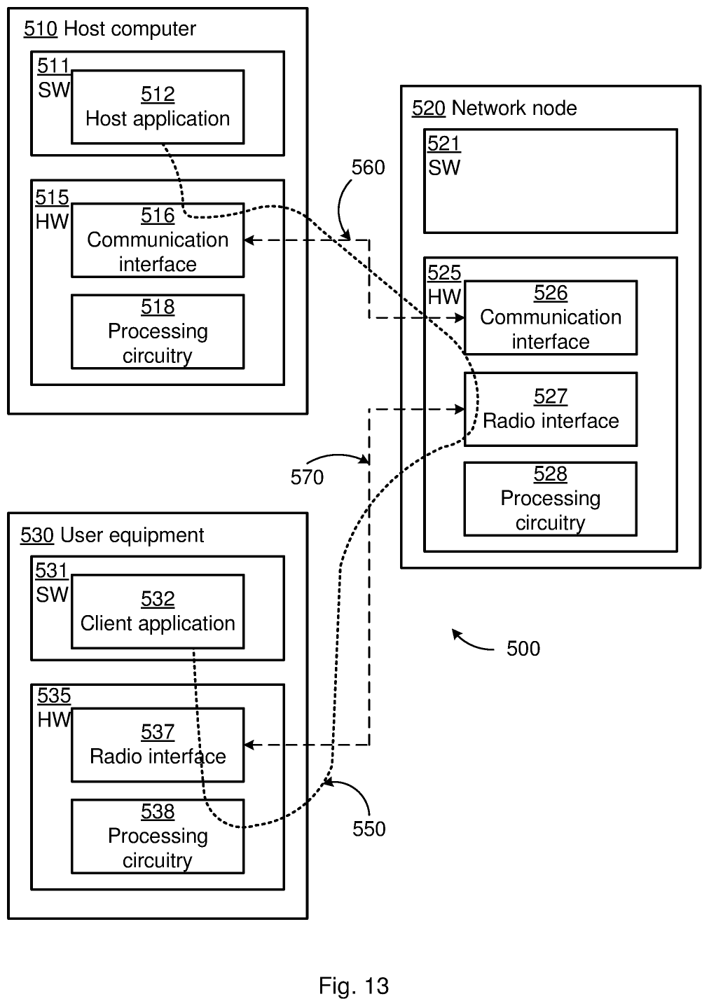

FIG. 13 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 13. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the UEs 170a:170K of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the network node 160 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 13) served by radio access network node 520. Communication interface 526 may be configured to facilitate connection 560 to host computer 510. Connection 560 may be direct or it may pass through a core network (not shown in FIG. 13) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 13 may be similar or identical to host computer 430, one of network nodes 412a, 412b, 412c and one of UEs 491, 492 of FIG. 12, respectively. This is to say, the inner workings of these entities may be as shown in FIG. 13 and independently, the surrounding network topology may be that of FIG. 12.

In FIG. 13, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signaling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for configuring agent entities with a reporting condition for reporting computational results during an iterative learning process, the method being performed by a server entity, the method comprising:
configuring the agent entities with a computational task and a reporting condition, wherein the agent entities are to contend for channel access to report computational results of the computational task to the server entity only when an importance metric m_k (t) satisfies the reporting condition; and
performing the iterative learning process with the agent entities until a termination criterion is met.

2. The method of claim 1, wherein the server entity during each iteration of the iterative learning process:
provides a parameter vector of the computational task to the agent entities;
obtains, in accordance with the reporting condition, computational results as a function of the parameter vector from the agent entities; and
updates the parameter vector as a function of an aggregate of the obtained computational results when the aggregate of the obtained computational results for the iteration fails to satisfy the termination criterion.

3. The method of claim 1, wherein the importance metric m_k (t) satisfies the reporting condition when the importance metric m_k (t) exceeds a threshold value t_k.

4. The method of claim 1, wherein, according to the configuring, the agent entities are to contend for channel access by performing a random access procedure.

5-7. (canceled)

8. A method, performed by an agent entity, for being configured by a server entity with a reporting condition for reporting computational results during an iterative learning process, the method comprising:
obtaining configuring in terms of a computational task and a reporting condition from the server entity, wherein the agent entity is to contend for channel access to report computational results of the computational task to the server entity only when an importance metric m_k (t) satisfies the reporting condition; and
performing the iterative learning process with the server entity until a termination criterion is met, wherein, as part of the learning process, the agent entity contends for channel access to report a computational result for an iteration of the learning process to the server entity only when the importance metric m_k (t) satisfies the reporting criterion.

9. The method of claim 8, wherein the agent entity during each iteration of the iterative learning process:
obtains a parameter vector of the computational task from the server entity;
determines the computational result of the computational task as a function of the obtained parameter vector for the iteration and of data locally obtained by the agent entity; and
contends for channel access to report the computational result for the iteration to the server entity only when the importance metric m_k (t) satisfies the reporting criterion.

10. The method of claim 8, wherein the importance metric m_k (t) satisfies the reporting condition when the importance metric m_k (t) exceeds a threshold value t_k.

11. The method of claim 10, wherein the importance metric m_k (t) is a function of a gradient update |∇_k(t)| computed by the agent entity as part of determining the computational result for iteration t of the iterative learning process, and wherein contention for channel access is made only when the gradient update for iteration t exceeds a threshold value t_k.

12. The method of claim 10, wherein the importance metric m_k (t) is a function of a channel quality value h_k (t), as valid for iteration t of the iterative learning process, for a radio propagation channel over which the computational result is to be reported, and wherein contention for channel access for iteration t is made only when the channel quality as valid for iteration t exceeds the threshold value t_k.

13. The method of claim 10, wherein the importance metric m_k (t) is a function of number of iterations n since recent-most contention for channel access was made, and wherein contention for channel access is made only when the number of iterations n of the iterative learning process exceeds the threshold value t_k.

14. The method of claim 10, wherein the importance metric m_k (t) is a function of number of iterations n of the iterative learning process since recent-most reporting of the computational result was made, and wherein contention for channel access is made only when the number of iterations n exceeds the threshold value t_k.

15. The method of claim 10, wherein the importance metric m_k (t) is a function of channel variation, over at least two iterations of the iterative learning process, of a radio propagation channel over which the computational result is to be reported, and wherein contention for channel access is made only when the channel variation exceeds the threshold value t_k.

16. The method of claim 10, wherein the importance metric m_k (t) is a function of a local parameter updated as part of performing a recent-most iteration of the iterative learning process, and wherein contention for channel access is made only when the local parameter exceeds the threshold value t_k.

17. The method of claim 10, wherein the importance metric m_k (t) is mapped onto an access probability value p, and wherein contention for channel access is made only when p>x, where x is a uniformly distributed random variable in an interval [0,1] and defines the threshold value t_k.

18. The method of claim 10, wherein the importance metric m_k (t) is a function of an attainable quality of service, QoS, value as attainable when reporting over the radio propagation channel, wherein the threshold value t_k is mapped onto a required QoS value as required for reporting the computational result, and wherein contention for channel access for iteration t is made only when the attainable QoS value exceeds the required QoS value.

19. The method of claim 18, wherein the attainable QoS value is determined from a channel quality value h_k (t), as valid for iteration t, for a radio propagation channel over which the computational result is to be reported.

20-24. (canceled)

25. A server entity for configuring agent entities with a reporting condition for reporting computational results during an iterative learning process, the server entity comprising processing circuitry, the processing circuitry being configured to cause the server entity to:
configure the agent entities with a computational task and a reporting condition, wherein the agent entities are to contend for channel access to report computational results of the computational task to the server entity only when an importance metric m_k (t) satisfies the reporting condition; and
perform the iterative learning process with the agent entities until a termination criterion is met.

26. (canceled)

27. The server entity of claim 25, further being configured to, during each iteration of the iterative learning process:
provides a parameter vector of the computational task to the agent entities;
obtains, in accordance with the reporting condition, computational results as a function of the parameter vector from the agent entities; and
updates the parameter vector as a function of an aggregate of the obtained computational results when the aggregate of the obtained computational results for the iteration fails to satisfy the termination criterion.

28. An agent entity for being configured by a server entity with a reporting condition for reporting computational results during an iterative learning process, the agent entity comprising processing circuitry, the processing circuitry being configured to cause the agent entity to:
obtain configuring in terms of a computational task and a reporting condition from the server entity, wherein the agent entity is to contend for channel access to report computational results of the computational task to the server entity only when an importance metric m_k (t) satisfies the reporting condition; and
perform the iterative learning process with the server entity until a termination criterion is met, wherein, as part of the learning process, the agent entity contends for channel access to report a computational result for an iteration of the learning process to the server entity only when the importance metric m_k (t) satisfies the reporting criterion.

29-33. (canceled)

34. The agent entity of claim 28, further being configured to, during each iteration of the iterative learning process:
obtain a parameter vector of the computational task from the server entity;
determine the computational result of the computational task as a function of the obtained parameter vector for the iteration and of data locally obtained by the agent entity; and
contend for channel access to report the computational result for the iteration to the server entity only when the importance metric m_k (t) satisfies the reporting criterion.
